(19) United States
(12) Patent Application Publication
(10) Pub. No.: US 2024/0274886 A1
(43) Pub. Date: Aug. 15, 2024

(54) STABLE ELECTROLYTE COMPOSITIONS FOR ELECTROCHEMICAL STORAGE SYSTEMS

(71) Applicant: Enevate Corporation, Irvine, CA (US)

(72) Inventors: Daniel Sylvinson Muthiah Ravinson, Irvine, CA (US); Vincent Giordani, Irvine, CA (US); Heidi Anderson, Irvine, CA (US); Benjamin Yong Park, Irvine, CA (US)

(21) Appl. No.: 18/102,621

(22) Filed: Jan. 27, 2023

(51) Int. Cl. H01M 10/0569

(52) U.S. Cl. CPC H01M 10/0569; H01M 2300/0037

(57) ABSTRACT

New electrolyte compositions for lithium-ion energy storage devices with silicon-based electrode materials having improved stability. The electrolyte compositions may be used in an energy storage device comprising a first electrode and a second electrode, where at least one of the first electrode and the second electrode is a Si-based electrode, a separator between the first electrode and the second electrode, and the electrolyte composition.

### CROSS-REFERENCE TO RELATED APPLICATIONS/INCORPORATION BY REFERENCE

N/A

### FIELD

Aspects of the present disclosure relate to energy generation and storage. More specifically, certain embodiments of the disclosure relate to electrolytes for use in lithium-ion energy storage devices with silicon-based anode materials.

### BACKGROUND

Conventional approaches for battery electrodes may be costly, cumbersome, and/or inefficient—e.g., they may be complex and/or time-consuming to implement, and may limit battery lifetime.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

New electrolyte compositions for lithium-ion energy storage devices which improve stability, substantially as shown in and/or described in connection with at least one of the figures, as set forth more completely in the claims.

These and other advantages, aspects, and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 illustrates an example battery, in accordance with an example embodiment of the disclosure.

FIG. 2 is a flow diagram of a lamination process for forming a silicon-dominant anode cell, in accordance with an example embodiment of the disclosure.

FIG. 3 is a flow diagram of a direct coating process for forming a silicon-dominant anode cell, in accordance with an example embodiment of the disclosure.

FIG. 4 illustrates an example battery management system (BMS) for use in managing operation of batteries, in accordance with an example embodiment of the disclosure.

FIG. 5 shows the performance of different ether-based electrolytes compared to a carbonate based electrolyte, in accordance with an example embodiment of the disclosure.

FIG. 6 shows normalized discharge capacity retention at room temperature and at high temperature cycling of 5-Layer pouch cells, in accordance with an example embodiment of the disclosure.

FIG. 7 shows gassing analysis of 5-Layer Si/NCM811 pouch cells, in accordance with an example embodiment of the disclosure.

### DETAILED DESCRIPTION

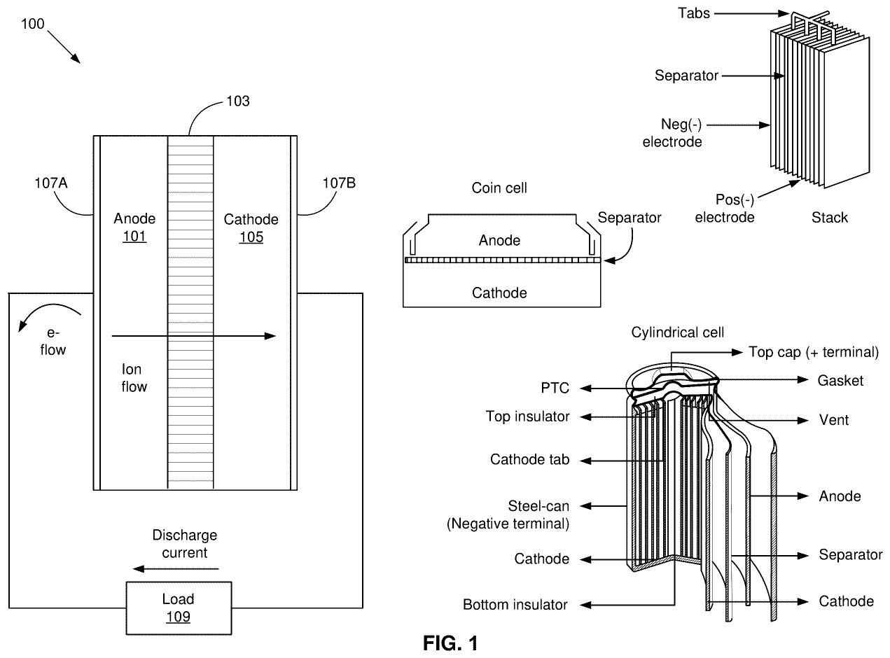

FIG. 1 illustrates an example battery. Referring to FIG. 1, there is shown a battery 100 comprising a separator 103 sandwiched between an anode 101 and a cathode 105, with current collectors 107A and 107B. There is also shown a load 109 coupled to the battery 100 illustrating instances when the battery 100 is in discharge mode. In this disclosure, the term “battery” may be used to indicate a single electrochemical cell, a plurality of electrochemical cells formed into a module, and/or a plurality of modules formed into a pack. Furthermore, the battery 100 shown in FIG. 1 is a very simplified example merely to show the principle of operation of a lithium-ion cell. Examples of realistic structures are shown to the right in FIG. 1, where stacks of electrodes and separators are utilized, with electrode coatings typically on both sides of the current collectors except, in certain cases, the outermost electrodes. The stacks may be formed into different shapes, such as a coin cell, cylindrical cell, prismatic pouch cell, or prismatic metal can cell, for example.

The development of portable electronic devices and electrification of transportation drive the need for high-performance electrochemical energy storage. In devices ranging from small-scale (<100 Wh) to large-scale (>10 kWh), Li ion batteries are widely used over other rechargeable battery chemistries due to their advantages in energy density and cyclability.

The anode 101 and cathode 105, along with the current collectors 107A and 107B, may comprise the electrodes, which may comprise plates or films within, or containing, an electrolyte material, where the plates may provide a physical barrier for containing the electrolyte as well as a conductive contact to external structures. In other embodiments, the anode/cathode plates are immersed in electrolyte while an outer casing provides electrolyte containment. The anode 101 and cathode 105 are electrically coupled to the current collectors 107A and 107B, which comprise metal or other conductive material for providing electrical contact to the electrodes as well as physical support for the active material in forming electrodes.

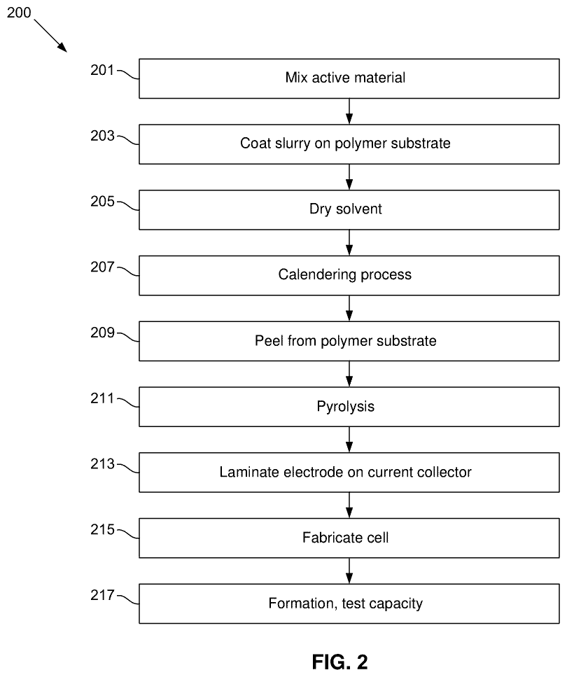

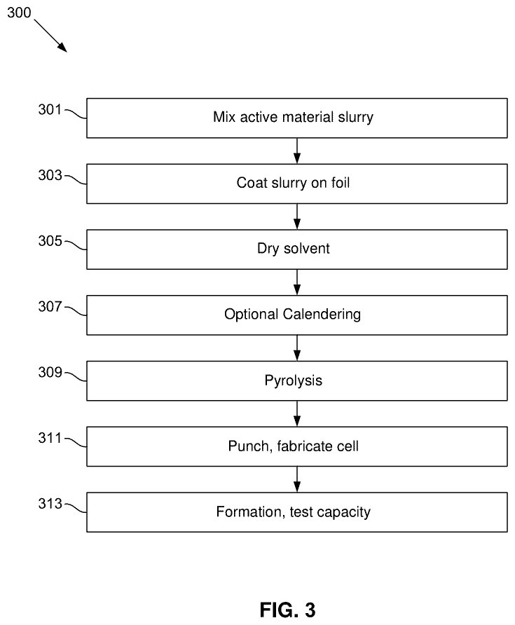

The configuration shown in FIG. 1 illustrates the battery 100 in discharge mode, whereas in a charging configuration, the load 109 may be replaced with a charger to reverse the process. In one class of batteries, the separator 103 is generally a film material, made of an electrically insulating polymer, for example, that prevents electrons from flowing from anode 101 to cathode 105, or vice versa, while being porous enough to allow ions to pass through the separator 103. Typically, the separator 103, cathode 105, and anode 101 materials are individually formed into sheets, films, or active material coated foils. In this regard, different methods or processes may be used in forming electrodes, particularly silicon-containing and/or silicon-dominant (>50% in terms of active material by capacity or by weight) anodes. For example, lamination or direct coating may be used in forming a silicon-containing anode (silicon anode). Examples of such processes are illustrated in and described with respect to FIGS. 2 and 3. Sheets of the cathode, separator and anode are subsequently stacked or rolled with the separator 103 separating the cathode 105 and anode 101 to form the battery 100. In some embodiments, the separator 103 is a sheet and generally utilizes winding methods and stacking in its manufacture. In these methods, the anodes, cathodes, and current collectors (e.g., electrodes) may comprise films.

In an example scenario, the battery 100 may comprise a solid, liquid, or gel electrolyte. The separator 103 preferably does not dissolve in typical battery electrolytes such as compositions that may comprise: Ethylene Carbonate (EC), Fluoroethylene Carbonate (FEC), Propylene Carbonate (PC), Dimethyl Carbonate (DMC), Ethyl Methyl Carbonate (EMC), Diethyl Carbonate (DEC), etc. with dissolved LiBF₄, LiAsF₆, LiPFe, and LiClO₄, LiFSI, LiTFSI, etc. In an example scenario, the electrolyte may comprise Lithium hexafluorophosphate (LiPFe) and lithium bis(trifluoromethanesulfonyl)imide (LiTFSI) that may be used together in a variety of electrolyte solvents. Lithium hexafluorophosphate (LiPFe) may be present at a concentration of about 0.1 to 4.0 molar (M) and lithium bis(trifluoromethanesulfonyl)imide (LiTFSI) may be present at a concentration of about 0 to 4.0 molar (M). Solvents may comprise one or more cyclic carbonates, such as ethylene carbonate (EC), fluoroethylene carbonate (FEC), or propylene carbonate (PC) as well as linear carbonates, such as ethyl methyl carbonate (EMC), diethyl carbonate (DEC), and dimethyl carbonate (DMC), in various percentages. In some embodiments, the electrolyte solvents may comprise one or more of EC from about 0-40%, FEC from about 2-40% and/or EMC from about 50-70% by weight.

The separator 103 may be soaked with a liquid or gel electrolyte. In addition, in an example embodiment, the separator 103 does not melt below about 100 to 140° C., and exhibits sufficient mechanical properties for battery applications. A battery, in operation, can experience expansion and contraction of the anode 101 and/or the cathode 105. In an example embodiment, the separator 103 can expand and contract by at least about 5 to 10% without tearing or otherwise failing, and may also be flexible.

The separator 103 may be sufficiently porous so that ions can pass through the separator once wet with, for example, a liquid or gel electrolyte. Alternatively (or additionally), the separator may absorb the electrolyte through a gelling or other process even without significant porosity. The porosity of the separator 103 is also generally not too porous to allow the anode 101 and cathode 105 to transfer electrons through the separator 103.

The anode 101 and cathode 105 comprise electrodes for the battery 100, providing electrical connections to the device for transfer of electrical charge in charge and discharge states. The anode 101 may comprise silicon, carbon, or combinations of these materials, for example. Typical anode electrodes comprise a carbon material and a current collector, such as a copper sheet. Carbon is often used because it has excellent electrochemical properties and is also electrically conductive. Anode electrodes currently used in rechargeable lithium-ion cells typically have a specific capacity of approximately 200 milliamp hours per gram (mAh/g). Graphite, the active material used in most lithium-ion battery anodes, has a theoretical energy density of 372 mAh/g. In comparison, silicon has a high theoretical capacity of 4200 mAh/g. In order to increase volumetric and gravimetric energy density of lithium-ion batteries, silicon may be used as the active material for the cathode 105 or anode 101. Si anodes may be in the form of a composite on a current collector, with >50% Si by capacity or weight in the composite layer.

In an example scenario, the anode 101 and cathode 105 store the ions used for separation of charge, such as lithium ions. In this example, the electrolyte carries positively charged lithium ions from the anode 101 to the cathode 105 in discharge mode, as shown in FIG. 1, and vice versa through the separator 103 in charge mode. The movement of the lithium ions and reactions with the electrodes create free electrons in one electrode which creates a charge at the opposite current collector. The electrical current then flows from the current collector where charge is created through the load 109 to the other current collector. The separator 103 blocks the flow of electrons inside the battery 100, allows the flow of lithium ions, and prevents direct contact between the electrodes.

While the battery 100 is discharging and providing an electric current, the anode 101 releases lithium ions to the cathode 105 through the separator 103, generating a flow of electrons from one side to the other via the coupled load 109. When the battery is being charged, the opposite happens where lithium ions are released by the cathode 105 and received by the anode 101.

The materials selected for the anode 101 and cathode 105 are important for the reliability and energy density possible for the battery 100. The energy, power, cost, and safety of current Li-ion batteries need to be improved in order to, for example, compete with internal combustion engine (ICE) technology and allow for the widespread adoption of electric vehicles (EVs). High energy density and high power density of lithium-ion batteries are achieved with the development of high-capacity and high-voltage cathodes, high-capacity anodes and electrolytes with high voltage stability and interfacial compatibility with electrodes. Functionally non-flammable or less-flammable electrolytes could be used to improve safety. In addition, materials with low toxicity are beneficial as battery materials to reduce process cost and promote consumer safety.

The performance of electrochemical electrodes, while dependent on many factors, is largely dependent on the robustness of electrical contact between electrode particles, as well as between the current collector and the electrode particles. The electrical conductivity of silicon anode electrodes may be improved by incorporating conductive additives with different morphological properties. Carbon black (Super P), vapor grown carbon fibers (VGCF), and a mixture of the two have previously been incorporated into the anode to improve electrical conductivity and otherwise improve performance. The synergistic interactions between the two carbon materials may facilitate electrical contact throughout the large volume changes of the silicon anode during charge and discharge as well as provide additional mechanical robustness to the electrode and provide mechanical strength (e.g., to keep the electrode material in place). These contact points (especially when utilizing high-aspect-ratio conductive materials) facilitate the electrical contact between anode material and current collector to mitigate the isolation (island formation) of the electrode material while also improving conductivity in between silicon regions. Graphenes and carbon nanotubes may be used because they may show similar benefits. Thus, in some instances, a mixture of two or more of carbon black, vapor grown carbon fibers, graphene, and carbon nanotubes may be used independently or in combinations for the benefits of conductivity and other performance.

State-of-the-art lithium-ion batteries typically employ a graphite-dominant anode which is a lithium intercalation type anode. Silicon-containing and especially silicon-dominant anodes, however, offer improvements compared to graphite-dominant Li-ion batteries. Silicon exhibits both higher gravimetric (4200 mAh/g vs. 372 mAh/g for graphite) and volumetric capacities (2194 mAh/L vs. 890 mAh/L for graphite). In addition, Si has a higher redox reaction potential versus Li compared to graphite, with a voltage plateau at about 0.3-0.4V vs. Li/Li+, which allows it to maintain an open circuit potential that avoids undesirable Li plating and dendrite formation. While silicon shows excellent electrochemical activity, achieving a stable cycle life for silicon-based anodes is challenging due to silicon's large volume changes during lithiation and delithiation. Silicon regions may lose electrical contact from the anode as large volume changes coupled with its low electrical conductivity separate the silicon from surrounding materials in the anode.

In addition, the large silicon volume changes exacerbate solid electrolyte interphase (SEI) formation, which can further lead to electrical isolation and, thus, capacity loss. Expansion and shrinkage of silicon particles upon charge-discharge cycling causes pulverization of silicon particles, which increases their specific surface area. As the silicon surface area changes and increases during cycling, SEI repeatedly breaks apart and reforms. The SEI thus continually builds up around the pulverizing silicon regions during cycling into a thick electronic and ionic insulating layer. This accumulating SEI increases the impedance of the electrode and reduces the electrode electrochemical reactivity, which is detrimental to cycle life. Therefore, silicon anodes require a strong conductive matrix that (a) holds silicon particles together in the anode, (b) is flexible enough to accommodate the large volume expansion and contraction of silicon, and (c) allows a fast conduction of electrons within the matrix.

Therefore, there is a trade-off among the functions of active materials, conductive additives and polymer binders. The balance may be adversely impacted by high energy density silicon anodes with low conductivity and huge volume variations described above. Polymer binder(s) may be pyrolyzed to create a pyrolytic carbon matrix with embedded silicon particles. In addition, the polymers may be selected from polymers that are completely or partially soluble in water or other environmentally benign solvents or mixtures and combinations thereof. Polymer suspensions of materials that are non-soluble in water could also be utilized.

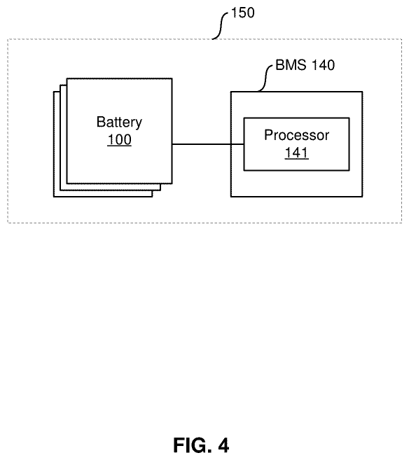

In some embodiments, dedicated systems and/or software may be used to control and manage batteries or packs thereof. In this regard, such dedicated systems may comprise suitable circuitry for running and/or executing control and manage related functions or operations. Further, such software may run on suitable circuitry, such as on processing circuitry (e.g., general processing units) already present in the systems or it may be implemented on dedicated hardware. For example, battery packs (e.g., those used in electric vehicles) may be equipped with a battery management system (BMS) for managing the batteries (or packs) and operations. An example battery management system (BMS) is illustrated in and described in more detail with respect to FIG. 4.

FIG. 2 is a flow diagram of an example lamination process for forming a silicon-containing or a silicon-dominant cell. This process employs a high-temperature pyrolysis process on a substrate, layer removal, and a lamination process to adhere the active material layer to a current collector. This strategy may also be adopted by other types of anodes, such as graphite, conversion type anodes, such as transition metal oxides, transition metal phosphides, and other alloy type anodes, such as Sn, Sb, Al, P, etc.

To fabricate an anode, the raw electrode active material is mixed in step 201. In the mixing process, the active material may be mixed with a binder/resin (such as water soluble PI (polyimide), PAI (polyamideimide), carboxymethyl cellulose (CMC), styrene-butadiene rubber (SBR), poly(acrylic acid) (PAA), Sodium Alginate, Phenolic or other water soluble resins and mixtures and combinations thereof), solvent, rheology modifiers, surfactants, pH modifiers, and conductive additives. The materials may comprise carbon nanotubes/fibers, graphene sheets, metal polymers, metals, semiconductors, and/or metal oxides, for example. Silicon powder with a 1-30 or 5-30 μm particle size, for example, may then be dispersed in polyamic acid resin, PAI, or PI (15-25% solids in N-Methyl pyrrolidone (NMP) or deionized (DI) water) at, e.g., 1000 rpm for, e.g., 10 minutes, and then the conjugated carbon/solvent slurry may be added and dispersed at, e.g., 2000 rpm for, e.g., 10 minutes to achieve a slurry viscosity within 2000-4000 cP and a total solid content of about 30-40%. The pH of the slurry can be varied from acidic to basic, which may be beneficial for controlling the solubility, conformation, or adhesion behavior of water soluble polyelectrolytes, such as polyamic acid, carboxymethyl cellulose, or polyacrylic acid. Ionic or non-ionic surfactants may be added to facilitate the wetting of the insoluble components of the slurry or the substrates used for coating processes. The particle size and mixing times may be varied to configure the electrode coating layer density and/or roughness.

Furthermore, cathode electrode coating layers may be mixed in step 201, and coated (e.g., onto aluminum), where the electrode coating layer may comprise cathode material mixed with carbon precursor and additive as described above for the anode electrode coating layer. The cathode material may comprise Lithium Nickel Cobalt Manganese Oxide (NMC (also called NCM): LiNiₓCo_{y}Mn_{z}O₂, x+y+z=1), Lithium Iron Phosphate (LFP: LiFePO₄/C), Lithium Nickel Manganese Spinel (LNMO: e.g. LiNi_{0.5}Mn_{1.5}O₄), Lithium Nickel Cobalt Aluminum Oxide (NCA: LiNiₐCo_{b}Al_{c}O₂, a+b+c=1), Lithium Manganese Oxide (LMO: e.g. LiMn₂O₄), a quaternary system of Lithium Nickel Cobalt Manganese Aluminum Oxide (NCMA: e.g. Li[Ni_{0.89}CO_{0.5}Mn_{0.05}Al_{0.01}]O₂, Lithium Cobalt Oxide (LCO: e.g. LiCoO₂), and other Li-rich layer cathodes or similar materials, or combinations thereof. The particle size and mixing times may be varied to configure the electrode coating layer density and/or roughness.

In step 203, the slurry may be coated on a substrate. In this step, the slurry may be coated onto a polyester, polyethylene terephthalate (PET), or Mylar film at a loading of, e.g., 2-4 mg/cm² and then undergo drying in step 205 to an anode coupon with high Si content and less than 15% residual solvent content. This may be followed by an optional calendering process in step 207, where a series of hard pressure rollers may be used to finish the film/substrate into a smoothed and denser sheet of material.

In step 209, the active-material-containing film may then be removed from the PET, where the active material layer may be peeled off the polymer substrate. The peeling may be followed by a pyrolysis step 211 where the material may be heated to, e.g., 600-1250° C. for 1-3 hours, cut into sheets, and vacuum dried using a two-stage process (120° C. for 15 h, 220° C. for 5 h). The peeling process may be skipped if polypropylene (PP) substrate is used, and PP can leave ˜2% char residue upon pyrolysis.

In step 213, the electrode material may be laminated on a current collector. For example, a 5-20 μm thick copper foil may be coated with polyamide-imide with a nominal loading of, e.g., 0.2-0.6 mg/cm² (applied as a 6 wt % varnish in NMP and dried for, e.g., 12-18 hours at, e.g., 110° C. under vacuum). The anode coupon may then be laminated on this adhesive-coated current collector. In an example scenario, the silicon-carbon composite film is laminated to the coated copper using a heated hydraulic press. An example lamination press process comprises 30-70 seconds at 300° C. and 3000-5000 psi, thereby forming the finished silicon-composite electrode.

In step 215, the cell may be formed. In this regard, the anode may be used to assemble a cell with cathode, separator and electrolyte materials. In some instances, separator with significant adhesive properties may be utilized.

In step 217, the cell may be assessed before being subject to a formation process. The measurements may comprise impedance values, open circuit voltage, and electrode and cell thickness measurements. The formation cycles are defined as any type of charge/discharge of the cell that is performed to prepare the cell for general cycling and is considered part of the cell production process. Different rates of charge and discharge may be utilized in formation steps. During formation, the initial lithiation of the anode may be performed, followed by delithiation. Cells may be clamped during formation and/or cycling.

FIG. 3 is a flow diagram of a direct coating process for forming a silicon-containing or a silicon-dominant cell. This process comprises physically mixing the active material, conductive additive, and binder together, and coating the mixed slurry directly on a current collector before pyrolysis. This example process comprises a direct coating process in which an anode or cathode slurry is directly coated on a copper foil using a binder such as CMC, SBR, PAA, Sodium Alginate, PAI, PI and mixtures and combinations thereof.

In step 301, the active material may be mixed with, e.g., a binder/resin (such as PI, PAI or phenolic), solvent (such as NMP, water, other environmentally benign solvents or their mixtures and combinations thereof), and conductive additives. The materials may comprise carbon nanotubes/fibers, graphene sheets, metal polymers, metals, semiconductors, and/or metal oxides, for example. Silicon powder with a 1-30 μm particle size, for example, may then be dispersed in polyamic acid resin, PAI, PI (15% solids in DI water or N-Methyl pyrrolidone (NMP)) at, e.g., 1000 rpm for, e.g., 10 minutes, and then the conjugated carbon/solvent slurry may be added and dispersed at, e.g., 2000 rpm for, e.g., 10 minutes to achieve a slurry viscosity within 2000-4000 cP and a total solid content of about 30-40%.

Furthermore, cathode active materials may be mixed in step 301, where the active material may comprise lithium cobalt oxide (LCO), lithium iron phosphate, lithium nickel cobalt manganese oxide (NMC), lithium nickel cobalt aluminum oxide (NCA), lithium manganese oxide (LMO), lithium nickel manganese spinel, or similar materials or combinations thereof, mixed with a binder as described above for the anode active material.

In step 303, the slurry may be coated on a copper foil. In the direct coating process described here, an anode slurry is coated on a current collector with residual solvent followed by a drying and a calendering process for densification. A pyrolysis step (˜500-800° C.) is then applied such that carbon precursors are partially or completely converted into glassy carbon or pyrolytic carbon. Similarly, cathode active materials may be coated on a foil material, such as aluminum, for example. The active material layer may undergo a drying process in step 305 to reduce residual solvent content. An optional calendering process may be utilized in step 307 where a series of hard pressure rollers may be used to finish the film/substrate into a smoother and denser sheet of material. In step 307, the foil and coating optionally proceeds through a roll press for calendering where the surface is smoothed out and the thickness is controlled to be thinner and/or more uniform.

In step 309, the active material may be pyrolyzed by heating to 500-1000° C. such that carbon precursors are partially or completely converted into glassy carbon. Pyrolysis can be done either in roll form or after punching. If the electrode is pyrolyzed in a roll form, it will be punched into individual sheets after pyrolysis. The pyrolysis step may result in an anode active material having silicon content greater than or equal to 50% by capacity or by weight. In an example scenario, the anode active material layer may comprise 20 to 95% silicon. In another example scenario may comprise 50 to 95% silicon by weight. In step 311, the cell may be formed, which may also include punching the electrode. In this regard, in instances where the current collector foil is not pre-punched/pre-perforated, the formed electrode may be punched. The formed electrode may be perforated with a punching roller, for example. The punched anodes may then be used to assemble a cell with cathode, separator and electrolyte materials. In some instances, separator with significant adhesive properties may be utilized.

In step 313, the cell may be assessed before being subject to a formation process. The measurements may comprise impedance values, open circuit voltage, and cell and/or electrode thickness measurements. During formation, the initial lithiation of the anode may be performed, followed by delithiation. Cells may be clamped during formation and/or early cycling. The formation cycles are defined as any type of charge/discharge of the cell that is performed to prepare the cell for general cycling and is considered part of the cell production process. Different rates of charge and discharge may be utilized in formation steps.

FIG. 4 illustrates an example battery management system (BMS) for use in managing operation of batteries. Shown in FIG. 4 is battery management system (BMS) 400.

The battery management system (BMS) 400 may comprise suitable circuitry (e.g., processor 410) configured to manage one or more batteries (e.g., each being an instance of the battery 100 as described with respect with FIG. 1). In this regard, the BMS 400 may be in communication and/or coupled with each battery 100. In some implementations, a separate processor (e.g., a conventional processor, such as an electronic control unit (ECU), a microcontroller unit (ECU), or the like), or several such separate processors, may be used, and may be configured to handle algorithms or control functions with regards to the batteries. In such implementations, such processor(s) may be connected to the batteries, such as through the processor 410, and thus may be treated as part of the BMS 400 and acting as part of processor 410.

In some embodiments, the battery 100 and the BMS 400 may be in communication and/or coupled with each other, for example, via electronics or wireless communication. In some embodiments, the BMS 400 may be incorporated into the battery 100. Alternatively, in some embodiments, the BMS 400 and the battery 100 may be combined into a common package 420. Further, in some embodiments, the BMS 400 and the battery 100 may be separate devices/components, and may only be in communication with one another when present in the same system. The disclosure is not limited to any particular arrangement, however.

As the demands for both zero-emission electric vehicles and grid-based energy storage systems increase, lower costs and improvements in energy density, power density, and safety of lithium (Li)-ion batteries are highly desirable. Enabling the high energy density and safety of Li-ion batteries requires the development of high-capacity, and high-voltage cathodes, high-capacity anodes and accordingly functional electrolytes with high voltage stability, interfacial compatibility with electrodes and safety.

As discussed above, a lithium-ion battery typically includes a separator and/or electrolyte between an anode and a cathode. In one class of batteries, the separator, cathode and anode materials are individually formed into sheets or films. Sheets of the cathode, separator and anode are subsequently stacked or rolled with the separator separating the cathode and anode (e.g., electrodes) to form the battery. Typical electrodes include electro-chemically active material layers on electrically conductive metals (e.g., aluminum and copper). Films can be rolled or cut into pieces which are then layered into stacks. The stacks are of alternating electro-chemically active materials with the separator between them.

Si is one of the most promising anode materials for Li-ion batteries due to its high specific gravimetric and volumetric capacity (discussed above), and low lithiation potential (<0.4 V vs. Li/Li⁺). For anodes, silicon-based materials can provide significant improvement in energy density. However, the large volumetric expansion (e.g., >300%) during the Li alloying/dealloying processes can lead to disintegration of the active material and the loss of electrical conduction paths, thereby reducing the cycling life of the battery. In addition, an unstable solid electrolyte interphase (SEI) layer can develop on the surface of the cycled anodes, and leads to an endless exposure of Si particle surfaces to the liquid electrolyte. This results in an irreversible capacity loss at each cycle due to the reduction at the low potential where the liquid electrolyte reacts with the exposed surface of the Si anode. In addition, oxidative instability of the conventional non-aqueous electrolyte takes place at voltages beyond 4.5 V, which can lead to accelerated decay of cycling performance. Because of the generally inferior cycle life of Si compared to graphite, only a small amount of Si or Si alloy is used in conventional anode materials.

Cathode materials may include, e.g., Lithium Nickel Cobalt Manganese Oxide (NMC (NCM): LiNiₓCo_{y}Mn_{z}O₂, x+y+z=1); Lithium Iron Phosphate (LFP: LiFePO₄/C); Lithium Nickel Manganese Spinel (LNMO: LiNi_{0.5}Mn_{1.5}O₄); Lithium Nickel Cobalt Aluminum Oxide (NCA: LiNiₐCo_{b}Al_{c}O₂, a+b+c=₁); Lithium Manganese Oxide (LMO: LiMn₂O₄); a quaternary system of Lithium Nickel Cobalt Manganese Aluminum Oxide Li[Ni_{0.89}Co_{0.05}Mn_{0.05}Al_{0.01}]O₂ (NCMA) and Lithium Cobalt Oxide (LCO: LiCoO₂). The cathode may suffer from an inferior stability and a low capacity retention at a high cut-off potential. The reasons can be ascribed to the unstable surface layer's gradual exfoliation, the continuous electrolyte decomposition, and the transition metal ion dissolution into electrolyte solution; further causes for inferior performance can be: (i) structural changes from layered to spinel upon cycling; (ii) Mn- and Ni-dissolution giving rise to surface side reactions at the graphite anode; and (iii) oxidative instability of conventional carbonate-based electrolytes at high voltage. Some limitations for certain cathodes are high cost, low thermal stability, and fast capacity fade at high current rates or during deep cycling.

As discussed above, typical electrodes include a current collector such as a copper sheet. Carbon is deposited onto the collector along with an inactive binder material. Carbon is often used because it has excellent electrochemical properties and is also electrically conductive. If the current collector layer (e.g., copper layer) was removed, the carbon would likely be unable to mechanically support itself. Therefore, conventional electrodes require a support structure such as the collector to be able to function as an electrode. The electrode (e.g., anode or cathode) compositions described in this application can produce electrodes that are self-supported. The need for a metal foil current collector is eliminated or minimized because conductive carbonized polymer is used for current collection in the anode structure as well as for mechanical support.

In order to increase volumetric and gravimetric energy density of lithium-ion batteries, silicon may be used as the active material for the cathode or anode. Several types of silicon materials, e.g., silicon nanopowders, silicon nanofibers, porous silicon, and ball-milled silicon, have also been reported as viable candidates as active materials for the negative or positive electrodes. Small particle sizes (for example, sizes in the nanometer range) generally can increase cycle life performance. They also can display very high initial irreversible capacity. However, small particle sizes also can result in very low volumetric energy density (for example, for the overall cell stack) due to the difficulty of packing the active material. Larger particle sizes, (for example, sizes in the micron range) generally can result in higher density anode material. However, the expansion of the silicon active material can result in poor cycle life due to particle cracking. For example, silicon can swell in excess of 300% upon lithium insertion. Because of this expansion, anodes including silicon should be allowed to expand while maintaining electrical contact between the silicon particles.

In some embodiments, a largest dimension of the silicon particles can be less than about 40 μm, less than about 1 μm, between about 10 nm and about 40 μm, between about 10 nm and about 1 μm, less than about 500 nm, less than about 100 nm, and about 100 nm. All, substantially all, or at least some of the silicon particles may comprise the largest dimension described above. For example, an average or median largest dimension of the silicon particles can be less than about 40 μm, less than about 1 μm, between about 10 nm and about 40 μm, between about 10 nm and about 1 μm, less than about 500 nm, less than about 100 nm, and about 100 nm.

The amount of silicon in the composite material can be greater than zero percent by weight of the mixture and composite material. In certain embodiments, the mixture comprises an amount of silicon, the amount being within a range of from about 0% to about 95% by weight, including from about 30% to about 95% by weight of the mixture. The amount of silicon in the composite material can be within a range of from about 0% to about 35% by weight, including from about 0% to about 25% by weight, from about 10% to about 35% by weight, and about 20% by weight. In further certain embodiments, the amount of silicon in the mixture is at least about 30% by weight; greater than 0% and less than about 95% by weight; or between about 50% and about 95% by weight (i.e. silicon dominant).

Additional embodiments of the amount of silicon in the electrode material (active material) include between about 30% and about 95% by weight, between about 50% and about 85% by weight, and between about 75% and about 95% by weight. In other embodiments, the amount of silicon in the electrode material may be at least about 30% by weight; greater than 0% and less than about 95% by weight; or between about 50% and about 95% by weight.

Further embodiments include percentages of silicon where the electrode material contains predominantly silicon. In some embodiments the amount of silicon may be greater than about 95%; or between about 95% and 100%. In further embodiments, the amount of silicon in the electrode material (active material) includes about 96%, 97%, 98% or 99%.

Furthermore, the silicon particles may or may not be pure silicon. For example, the silicon particles may be substantially silicon or may be a silicon alloy. In one embodiment, the silicon alloy includes silicon as the primary constituent along with one or more other elements.

As described herein, micron-sized silicon particles can provide good volumetric and gravimetric energy density combined with good cycle life. In certain embodiments, to obtain the benefits of both micron-sized silicon particles (e.g., high energy density) and nanometer-sized silicon particles (e.g., good cycle behavior), silicon particles can have an average particle size in the micron range and a surface including nanometer-sized features. In some embodiments, the silicon particles have an average particle size (e.g., average diameter or average largest dimension) between about 0.1 μm and about 30 μm or between about 0.1 μm and all values up to about 30 μm. For example, the silicon particles can have an average particle size between about 0.5 μm and about 25 μm, between about 0.5 μm and about 20 μm, between about 0.5 μm and about 15 μm, between about 0.5 μm and about 10 μm, between about 0.5 μm and about 5 μm, between about 0.5 μm and about 2 μm, between about 1 μm and about 20 μm, between about 1 μm and about 15 μm, between about 1 μm and about 10 μm, between about 5 μm and about 20 μm, etc. Thus, the average particle size can be any value between about 0.1 μm and about 30 μm, e.g., 0.1 μm, 0.5 μm, 1 μm, 5 μm, 10 μm, 15 μm, 20 μm, 25 μm, and 30 μm.

Cathode electrodes (positive electrodes) described herein may include metal oxide cathode materials, such as Lithium Cobalt Oxide (LiCoO₂) (LCO), Ni-rich oxides, high voltage cathode materials, lithium-rich oxides, nickel-rich layered oxides, lithium rich layered oxides, high-voltage spinel oxides, and high-voltage polyanionic compounds. Ni-rich oxides and/or high voltage cathode materials may include NCM, NCMA, and NCA. Example of NCM materials include, but are not limited to, LiNi_{0.6}Co_{0.2}Mn_{0.2}O₂ (NCM-622) and LiNi_{0.8}Co_{0.1}Mn_{0.1}O₂ (NCM-811). Lithium rich oxides may include xLi₂Mn₃O₂·(1−x)LiNiₐCo_{b}Mn_{c}O₂. Nickel-rich layered oxides may include LiNi₁₊ₓM₁₋ₓO₂ (where M=Co, Mn or Al). Lithium rich layered oxides may include LiNi₁₊ₓM₁₋ₓO₂ (where M=Co, Mn or Ni). High-voltage spinel oxides may include LiNi_{0.5}Mn_{1.5}O₄. High-voltage polyanionic compounds may include phosphates, sulfates, silicates, etc.

In certain embodiments, the positive electrode may be one of NCA, NCM, NMCA, LMO or LCO. The NCM cathodes include NCM 9 0.5 0.5, NCM811, NCM622, NCM532, NCM433, NCM111, and others. In further embodiments, the positive electrode comprises a lithium-rich layered oxide xLi₂MnO₃·(1−x)LiNiₐCo_{b}Mn_{c}O₂; nickel-rich layered oxide LiNi₁₋ₓMₓO₂ (M=Co, Mn and Al); or lithium rich layered oxide LiNi₁₊ₓM₁₋ₓO₂ (M=Co, Mn and Ni) cathode. In some embodiments, the disclosed solvent systems are used for Si-dominant anode/LiCoO₂ (LCO), LiNiₓCo_{y}Mn_{z}O₂ (NCM, 0≤x, y, z<1) or LiNiₓCo_{y}Al_{z}O₂ (NCA, 0≤x, y, z<1) cathode full cells.

As discussed above, Li-ion batteries are being intensively pursued in the electric vehicle markets and stationary energy storage devices. To further improve the cell energy density, high-voltage layered transition metal oxide cathodes, examples including Ni-rich (e.g. NCA, NCM), Li-rich cathodes, and high capacity and low-voltage anodes, such as Si, Ge, etc may be utilized. However, the performance deterioration of full cells, in which these oxides are paired with a Si or other high capacity anodes, increases markedly at potentials exceeding 4.30 V, limiting their wider use as high-energy cathode materials. Electrolyte decomposition at the electrolyte/electrode interface may cause accumulation of decomposed adducts on the NCM cathode surface. This hinders Li⁺ migration between the electrolyte and electrode, which in turn results in the rapid fading of the cycling performance. Thus the practical integration of a silicon anode in Li-ion batteries faces challenges such as large volume changes, an unstable solid-electrolyte interphase, electrolyte drying out, etc.

One strategy for overcoming these barriers includes exploring new electrolyte compositions in order to make good use of Si anode-based full cells. Electrolyte compositions should be able to assist in forming a uniform, stable SEI layer on the surface of Si anodes. This layer should have low impedance and be electronically insulating, but ionically conductive to Li-ion. Additionally, the SEI layer should have excellent elasticity and mechanical strength to overcome the problem of expansion and shrinkage of the Si anode volume. On the cathode side, the ideal electrolyte composition should be oxidized preferentially to the solvent molecule in the bare electrolyte, resulting in a protective cathode electrolyte interphase (CEI) film formed on the surface of the cathodes. At the same time, it should help alleviate the dissolution phenomenon of transition metal ions and decrease surface resistance on cathode side. In addition, the physical properties of the electrolyte may also be improved, such as ionic conductivity, viscosity, and wettability.

Thus, the next generation of electrolyte compositions are described herein. These materials may help modify cathode surfaces, forming stable CEI layers, or may form a stable, electronically insulating but ionically conducting SEI layer on the surface of Si anodes. These materials may also increase the electrochemical stability of Li-ion batteries when cycled at higher voltages and help with calendar life of the batteries. In addition, to alleviate battery safety concerns, these materials may impart an increased thermal stability to the organic components of the electrolyte, drive a rise in the flash point of the electrolyte formulations, increase the flame-retardant effectiveness and enhance thermal stability of SEI or CEI layers on the surface of electrodes. Further, the materials may produce one or more of the following benefits: increased cycle life, increased energy density, increased safety, decreased electrolyte consumption and/or decreased gassing.

An electrolyte composition for a lithium ion battery can include one or more solvents, one or more lithium ion sources (such as lithium-containing salts), and may also contain optional additives. The composition of the electrolyte may be selected to provide a lithium ion battery with improved performance. In some embodiments, the electrolyte may contain an electrolyte additive. As described herein, a lithium ion battery may include a first electrode, a second electrode, a separator between the first electrode and the second electrode, and an electrolyte in contact with the first electrode, the second electrode, and the separator. The electrolyte serves to facilitate ionic transport between the first electrode and the second electrode. In some embodiments, the first electrode and the second electrode can refer to anode and cathode or cathode and anode, respectively. Electrolytes and/or electrolyte compositions may be a liquid, solid, or gel.

In lithium-ion batteries, the most widely used electrolyte compositions are non-aqueous liquid electrolytes; these may comprise a lithium-containing salt (e.g. LiPF₆) and low molecular weight carbonate solvents as well as various small amounts of functional additives.

In some embodiments, the electrolyte can include more than one solvent. For example, the electrolyte may include two or more co-solvents. In some embodiments, the co-solvent may be selected from the group consisting of FEC, ethyl methyl carbonate (EMC), 1,1,2,2-tetrafluoroethyl 2,2,3,3-tetrafluoropropyl ether, difluoroethylene carbonate (F2EC), ethylene carbonate (EC), diethyl carbonate (DEC), dimethyl carbonate (DMC), propylene carbonate (PC), Dimethoxy ethane (DME), gamma-butyrolactone (GBL), methyl acetate (MA), ethyl acetate (EA), methyl propanoate, trans-butylene carbonate (t-BC), propyl methyl carbonate (PMC), etc.

In some embodiments, at least one of the co-solvents in the electrolyte is a fluorine-containing compound. In some embodiments, the fluorine-containing compound may be fluoroethylene carbonate (FEC), or difluoroethylene carbonate (F2EC). In some embodiments, the electrolyte contains FEC. In some embodiments, the electrolyte contains both EMC and FEC. In some embodiments, the electrolyte may further contain 1,1,2,2-tetrafluoroethyl 2,2,3,3-tetrafluoropropyl ether, EC, DEC, DMC, PC, GBL, and/or F2EC or some partially or fully fluorinated linear or cyclic carbonates, ethers, etc. as a co-solvent. In some embodiments, the electrolyte is free or substantially free of non-fluorine-containing cyclic carbonates, such as EC, GBL, and PC.

In some embodiments, the electrolyte for a lithium ion battery may include one or more solvents comprising a fluorine-containing component, such as a fluorine-containing cyclic carbonate, a fluorine-containing linear carbonate, and/or a fluoroether.

In further embodiments, electrolyte solvents may be composed of a cyclic carbonate, such as fluoroethylene carbonate (FEC), di-fluoroethylene carbonate (DiFEC), Trifluoropropylene carbonate (TFPC), ethylene carbonate (EC), propylene carbonate (PC), etc; a linear carbonate, such as dimethyl carbonate (DMC), diethyl carbonate (DEC), ethyl methyl carbonate (EMC), etc, or other solvents, such as methyl acetate, ethyl acetate, or gamma butyrolactone, dimethoxyethane, 1,1,2,2-tetrafluoroethyl 2,2,3,3-tetrafluoropropyl ether, etc.

In some embodiments, the electrolyte composition may comprise a system of solvents (i.e. a solvent, plus one or more co-solvents). The solvents may be fluorinated or non-fluorinated. In some embodiments, the co-solvents may be one or more linear carbonates, lactones, ethers, sulfonamides, acetates, propanoates and/or non-linear carbonates.

As used herein, a co-solvent in an electrolyte composition has a concentration of at least about 10% by volume (vol %). In some embodiments, a co-solvent of the electrolyte may be about 20 vol %, about 40 vol %, about 60 vol %, or about 80 vol %, or about 90 vol % of the electrolyte composition. In some embodiments, a co-solvent may have a concentration from about 10 vol % to about 90 vol %, from about 10 vol % to about 80 vol %, from about 10 vol % to about 60 vol %, from about 20 vol % to about 60 vol %, from about 20 vol % to about 50 vol %, from about 30 vol % to about 60 vol %, or from about 30 vol % to about 50 vol %. The co-solvents may also be denoted in percent by weight, where a co-solvent in an electrolyte composition has a concentration of at least about 10% by weight (wt %). In some embodiments, a co-solvent of the electrolyte may be about 20 wt %, about 40 wt %, about 60 wt %, or about 80 wt %, or about 90 wt % of the electrolyte composition. In some embodiments, a co-solvent may have a concentration from about 10 wt % to about 90 wt %, from about 10 wt % to about 80 wt %, from about 10 wt % to about 60 wt %, from about 20 wt % to about 60 wt %, from about 20 wt % to about 50 wt %, from about 30 wt % to about 60 wt %, or from about 30 wt % to about 50 wt %. Amounts may be measured as percent of total solvent.

In some embodiments, the electrolyte composition is substantially free of cyclic carbonates other than fluorine-containing cyclic carbonates (i.e., non-fluorine-containing cyclic carbonates). Examples of non-fluorine-containing carbonates include EC, PC, GBL, and vinylene carbonate (VC). In one embodiment, the electrolyte composition is substantially free of EC.

In some embodiments, the electrolyte composition may further comprise one or more additives that may impart desired characteristics to the mixture. An additive of the electrolyte refers to a component that makes up less than 30% by weight (wt %) of the electrolyte; in some embodiments, the additive makes up less than 10% by weight (wt %) of the electrolyte. In some embodiments, the amount of each additive in the electrolyte may be from about 0.2 wt % to about 1 wt %, 0.1 wt % to about 2 wt %, 0.2 wt % to about 9 wt %, from about 0.5 wt % to about 9 wt %, from about 1 wt % to about 9 wt %, from about 1 wt % to about 8 wt %, from about 1 wt % to about 8 wt %, from about 1 wt % to about 7 wt %, from about 1 wt % to about 6 wt %, from about 1 wt % to about 5 wt %, from about 2 wt % to about 5 wt %, or any value in between. In some embodiments, the total amount of the additive(s) may be from about 1 wt % to about 9 wt %, from about 1 wt % to about 8 wt %, from about 1 wt % to about 7 wt %, from about 2 wt % to about 7 wt %, or any value in between. In further embodiments, the electrolyte composition may contain the compound as an additive at less than 1 wt % or less; in other embodiments, about 0.5 wt % or less or about 0.2 wt % or less is utilized. In some embodiments, the additive may be present at up to 30% by weight; in some embodiments, the additive is present in about 0.1%-30% by weight; about 0.1%-20% by weight or 0.1%-10% by weight. In some embodiments, the percentages of additives may be expressed in volume percent (vol %) or in wt/vol %.

In certain embodiments, SEI-forming additives may be added. These SEI-forming additives include, but are not limited to, FEC (Fluoroethylene carbonate), VC (vinylene carbonate), VEC (Vinyl ethylene carbonate), PS (1,3-propane sultone), PES (prop-1-ene-1,3-sultone), MMDS (methylene methanedisulfonate), TMSP (tris(trimethylsilyl) phosphite), TMS (trimethylene sulfate), TMSO (3-trimethylsilyl-2-oxazolidinone), 1,4-BS (1,4-butane sultone), PMS (propargyl methanesulfonate), BP (biphenyl), DTD (1,3,2-Dioxathiolane 2,2-dioxide), TAP (Triallyl phosphate), etc. These additives may be present in about 0.1-30% by weight; about 0.1%-20% by weight or 0.1%-10% by weight.

In some embodiments, solvents may function as an additive instead of a co-solvent, if it is present in an amount less than 10%. Solvents as additives may be present in concentrations as listed above (as low as 0.1% by weight). The same materials may also function as co-solvents at higher concentrations. In some embodiments, components of the electrolyte composition may be present in amounts from about 0.1% to about 80% by weight. In other embodiments, components may be present in amounts from about 0.1% to about 60% by weight; from about 0.1% to about 40% by weight; from about 0.1% to about 20% by weight; or from about 0.1% to about 10% by weight, or less.

In some embodiments, the electrolyte composition may contain a solvent as an additional component. In certain embodiments, the additional component may be one or more solvents including but not limited to EC (ethylene carbonate), FEC (Fluoroethylene carbonate), PC (propylene carbonate), EMC (ethyl methyl carbonate), DMC (dimethyl carbonate), DEC (diethyl carbonate), GBL (gamma butyrolactone), MA (methyl acetate), EA (ethyl acetate), t-BC (trans-butylene carbonate), PMC (propyl methyl carbonate), etc. In some embodiments, additional component solvents of the electrolyte composition may be present in amounts from about 0.1% to about 80% by weight. In other embodiments, components may be present in amounts from about 0.1% to about 60% by weight; from about 0.1% to about 40% by weight; from about 0.1% to about 20% by weight; or from about 0.1% to about 10% by weight, or less.

In some embodiments, one or more salts may be included in the electrolyte compositions, such as a lithium-containing salt. A lithium-containing salt for a lithium ion battery may comprise a fluorinated or non-fluorinated salt. In further embodiments, a lithium-containing salt for a lithium ion battery may comprise one or more of lithium hexafluorophosphate (LiPF₆), lithium nitrate (LiNO₃), lithium tetrafluoroborate (LiBF₄), lithium hexafluoroarsenate monohydrate (LiAsF₆), lithium perchlorate (LiClO₄), lithium bis(trifluoromethanesulfonyl)imide (LiTFSI), lithium bis(fluorosulfonyl)imide (LiFSI), lithium bis(oxalato)borate (LiBOB), lithium difluoro(oxalate)borate (LiDFOB), lithium triflate (LiCF₃SO₃), lithium tetrafluorooxalato phosphate (LTFOP), lithium difluorophosphate (LiPO₂F₂), lithium pentafluoroethyltrifluoroborate (LiFAB), and lithium 2-trifluoromethyl-4,5-dicyanoimidazole (LiTDI), lithium bis(2-fluoromalonato)borate (LiBFMB), lithium 4-pyridyl trimethyl borate (LPTB), lithium 2-fluorophenol trimethyl borate (LFPTB), lithium catechol dimethyl borate (LiCDMB), lithium tetrafluorooxalatophosphate (LiFOP), etc. or combinations thereof. In certain embodiments, a lithium-containing salt for a lithium ion battery may comprise lithium hexafluorophosphate (LiPF₆). In some embodiments, the electrolyte can have a salt concentration of about 1 moles/L (M). In other embodiments, the salt concentration can be higher than 1 M; or the salt concentration can be higher than 1.2M, 1.5M, 2M, 3M or 4M or more. The weight percent of salt in the electrolyte composition may be up to about 25% by weight (in some embodiments it may be about 10-20 wt %) with solvents making up the rest of the weight. In some embodiments, the concentration of a salt may be less than 1 M, such as 0.1-0.7M. Lower concentration ranges are useful when two or more salts are used as one may be a major component and the other a minor component.

In certain embodiments, the salt may be one or more of lithium bis(fluorosulfonyl)imide (LiFSI), lithium hexafluorophosphate (LiPF₆), lithium tetrafluoroborate (LiBF₄), bis(trifluoromethanesulfonyl)imide (LiTFSI), lithium nitrate (LiNO₃), lithium perchlorate (LiClO₄), Lithium difluoro(oxalato)borate (LiDFOB) and/or Lithium bis(oxalato)borate (LiBOB). In other embodiments, the salt may be one or more of lithium bis(fluorosulfonyl)imide (LiFSI), lithium hexafluorophosphate (LiPF₆), lithium nitrate (LiNO₃), Lithium difluoro(oxalato)borate (LiDFOB) and/or Lithium bis(oxalato)borate (LiBOB). The salt concentration can be 0.5M, 0.8M, 1 M, 1.2M, 1.5M, 2M, 3M or 4M or higher. In some embodiments, the concentration is less than 1 M, such as 0.1-0.7M. Lower concentration ranges are useful when two or more salts are used as one may be a major component and the other a minor component of the electrolyte composition.

Most Li-ion cells use carbonate-based electrolytes as discussed above. Carbonate-based electrolytes were developed and optimized for Lithium ion cells using graphite anodes. However, when used with high-capacity anode active materials like silicon or lithium metal, etc., they tend to exhibit poor cycling performance.

In the present disclosure, using ether and/or sulfonamide solvents in electrolyte compositions is described. Ether and sulfonamide solvents may be more suitable alternative to carbonates due to their lower reduction potential. However, commonly used ethers like DME, glymes, dioxolane etc. also have low oxidation potentials (˜3.9V) rendering them incompatible with high voltage cathodes like NCMA, NCA, NCM, etc. Disclosed herein are new ether-based and sulfonamide-based electrolytes with higher oxidation potentials that are simultaneously compatible with both high voltage cathodes and high capacity anodes like Si, SiOx, or Li metal.

The electrolyte composition may comprise ether and/or sulfonamide solvents, as described herein. In some embodiments, the electrolyte composition may contain the ether and/or sulfonamide solvents at a concentration of at least 10 vol %. In some embodiments, a solvent of the electrolyte may be about 20 vol %, about 30 vol %, about 40 vol %, about 50 vol %, about 60 vol %, about 70 vol %, about 80 vol %, or about 90 vol % of the electrolyte composition. In other embodiments, a solvent of the electrolyte may be about from about 10 vol % to about 90 vol %, from about 10 vol % to about 80 vol %, from about 10 vol % to about 60 vol %, from about 20 vol % to about 60 vol %, from about 20 vol % to about 50 vol %, from about 30 vol % to about 60 vol %, from about 30 vol % to about 70 vol % or from about 30 vol % to about 50 vol %. The solvents may also be denoted in percent by weight, where a solvent in an electrolyte composition has a concentration of at least about 10% by weight (wt %). In some embodiments, a solvent of the electrolyte may be about 20 wt %, about 30 wt %, about 40 wt %, about 50 wt %, about 60 wt %, about 70 wt %, about 80 wt %, or about 90 wt % of the electrolyte composition. In some embodiments, a solvent may have a concentration from about 10 wt % to about 90 wt %, from about 10 wt % to about 80 wt %, from about 10 wt % to about 60 wt %, from about 20 wt % to about 60 wt %, from about 20 wt % to about 50 wt %, from about 30 wt % to about 60 wt %, from about 30 wt % to about 70 wt % or from about 30 wt % to about 50 wt %. Amounts may be measured as percent of total solvent.

Example structures of ether and sulfonamide solvents are shown below.

The term “alkyl” refers to a straight or branched, saturated, aliphatic radical having the number of carbon atoms indicated. The alkyl moiety may be branched or straight chain. For example, C1-C6 alkyl includes, but is not limited to, methyl, ethyl, propyl, isopropyl, butyl, isobutyl, sec-butyl, tert-butyl, pentyl, isopentyl, hexyl, etc. Other alkyl groups include, but are not limited to heptyl, octyl, nonyl, decyl, etc. Alkyl can include any number of carbons, such as 1-2, 1-3, 1-4, 1-5, 1-6, 1-7, 1-8, 1-9, 1-10, 1-11, 1-12 2-3, 2-4, 2-5, 2-6, 3-4, 3-5, 3-6, 4-5, 4-6 and 5-6. The alkyl group is typically monovalent, but can be divalent, such as when the alkyl group links two moieties together.

The term “fluoro-alkyl” refers to an alkyl group where one, some, or all hydrogen atoms have been replaced by fluorine.

The term “alkylene” refers to an alkyl group, as defined above, linking at least two other groups, i.e., a divalent hydrocarbon radical. The two moieties linked to the alkylene can be linked to the same atom or different atoms of the alkylene. For instance, a straight chain alkylene can be the bivalent radical of —(CH₂)ₙ—, where n is 1, 2, 3, 4, 5, 6, 7, 8, 9, or 10. Alkylene groups include, but are not limited to, methylene, ethylene, propylene, isopropylene, butylene, isobutylene, sec-butylene, pentylene and hexylene.

The term “alkoxy” refers to alkyl group having an oxygen atom that either connects the alkoxy group to the point of attachment or is linked to two carbons of the alkoxy group. Alkoxy groups include, for example, methoxy, ethoxy, propoxy, iso-propoxy, butoxy, 2-butoxy, iso-butoxy, sec-butoxy, tert-butoxy, pentoxy, hexoxy, etc. The alkoxy groups can be further substituted with a variety of substituents described within. For example, the alkoxy groups can be substituted with halogens to form a “halo-alkoxy” group, or substituted with fluorine to form a “fluoro-alkoxy” group.

The term “alkenyl” refers to either a straight chain or branched hydrocarbon of 2 to 6 carbon atoms, having at least one double bond. Examples of alkenyl groups include, but are not limited to, vinyl, propenyl, isopropenyl, 1-butenyl, 2-butenyl, isobutenyl, butadienyl, 1-pentenyl, 2-pentenyl, isopentenyl, 1,3-pentadienyl, 1,4-pentadienyl, 1-hexenyl, 2-hexenyl, 3-hexenyl, 1,3-hexadienyl, 1,4-hexadienyl, 1,5-hexadienyl, 2,4-hexadienyl, or 1,3,5-hexatrienyl. Alkenyl groups can also have from 2 to 3, 2 to 4, 2 to 5, 3 to 4, 3 to 5, 3 to 6, 4 to 5, 4 to 6 and 5 to 6 carbons. The alkenyl group is typically monovalent, but can be divalent, such as when the alkenyl group links two moieties together.

The term “alkenylene” refers to an alkenyl group, as defined above, linking at least two other groups, i.e., a divalent hydrocarbon radical. The two moieties linked to the alkenylene can be linked to the same atom or different atoms of the alkenylene. Alkenylene groups include, but are not limited to, ethenylene, propenylene, isopropenylene, butenylene, isobutenylene, sec-butenylene, pentenylene and hexenylene.

The term “alkynyl” refers to either a straight chain or branched hydrocarbon of 2 to 6 carbon atoms, having at least one triple bond. Examples of alkynyl groups include, but are not limited to, acetylenyl, propynyl, 1-butynyl, 2-butynyl, isobutynyl, sec-butynyl, butadiynyl, 1-pentynyl, 2-pentynyl, isopentynyl, 1,3-pentadiynyl, 1,4-pentadiynyl, 1-hexynyl, 2-hexynyl, 3-hexynyl, 1,3-hexadiynyl, 1,4-hexadiynyl, 1,5-hexadiynyl, 2,4-hexadiynyl, or 1,3,5-hexatriynyl. Alkynyl groups can also have from 2 to 3, 2 to 4, 2 to 5, 3 to 4, 3 to 5, 3 to 6, 4 to 5, 4 to 6 and 5 to 6 carbons. The alkynyl group is typically monovalent, but can be divalent, such as when the alkynyl group links two moieties together.

The term “alkynylene” refers to an alkynyl group, as defined above, linking at least two other groups, i.e., a divalent hydrocarbon radical. The two moieties linked to the alkynylene can be linked to the same atom or different atoms of the alkynylene. Alkynylene groups include, but are not limited to, ethynylene, propynylene, butynylene, sec-butynylene, pentynylene, and hexynylene.

The term “cycloalkyl” refers to a saturated or partially unsaturated, monocyclic, fused bicyclic, bridged polycyclic, or spiro ring assembly containing from 3 to 12, from 3 to 10, or from 3 to 7 ring atoms, or the number of atoms indicated. Monocyclic rings include, for example, cyclopropyl, cyclobutyl, cyclopentyl, cyclohexyl, and cyclooctyl. Bicyclic and polycyclic rings include, for example, norbornane, decahydronaphthalene and adamantane. For example, C3-C8 cycloalkyl includes cyclopropyl, cyclobutyl, cyclopentyl, cyclohexyl, cyclooctyl, and norbornane. As used herein, the term “fused” refers to two rings which have two atoms and one bond in common. For example, in the following structure, rings A and B are fused

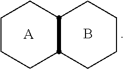

As used herein, the term “bridged polycyclic” refers to compounds wherein the cycloalkyl contains a linkage of one or more atoms connecting non-adjacent atoms. The following structures

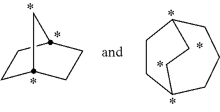 [SMILES: C1C[C@H]2CC[C@H]1C2 ; C1CC2CCC(C1)CC2]

and are examples of “bridged” rings. As used herein, the term “spiro” refers to two rings that have one atom in common and the two rings are not linked by a bridge. Examples of fused cycloalkyl groups are decahydronaphthalenyl, dodecahydro-1H-phenalenyl and tetradecahydroanthracenyl; examples of bridged cycloalkyl groups are bicyclo[1.1.1]pentyl, adamantanyl, and norbornanyl; and examples of spiro cycloalkyl groups include spiro[3.3]heptane and spiro[4.5]decane.

The term “cycloalkylene” refers to a cycloalkyl group, as defined above, linking at least two other groups, i.e., a divalent hydrocarbon radical. The two moieties linked to the cycloalkylene can be linked to the same atom or different atoms of the cycloalkylene. Cycloalkylene groups include, but are not limited to, cyclopropylene, cyclobutylene, cyclopentylene, cyclohexylene, and cyclooctylene.

The term “aryl” refers to a monocyclic or fused bicyclic, tricyclic or greater, aromatic ring assembly containing 6 to 16 ring carbon atoms. For example, aryl may be phenyl, benzyl or naphthyl, preferably phenyl. Aryl groups may include fused multicyclic ring assemblies wherein only one ring in the multicyclic ring assembly is aromatic. Aryl groups can be mono-, di-, or tri-substituted by one, two or three radicals. Preferred as aryl is naphthyl, phenyl, or phenyl mono- or disubstituted by alkoxy, phenyl, halogen, alkyl or trifluoromethyl, especially phenyl or phenyl-mono- or disubstituted by alkoxy, halogen or trifluoromethyl, and in particular phenyl.

The term “arylene” refers to an aryl group, as defined above, linking at least two other groups. The two moieties linked to the arylene are linked to different atoms of the arylene. Arylene groups include, but are not limited to, phenylene.

The term “heteroaryl” refers to a monocyclic or fused bicyclic or tricyclic aromatic ring assembly containing 5 to 16 ring atoms, where from 1 to 4 of the ring atoms are a heteroatom such as N, O, or S. For example, heteroaryl includes pyridyl, indolyl, indazolyl, quinoxalinyl, quinolinyl, isoquinolinyl, benzothienyl, benzofuranyl, furanyl, pyrrolyl, thiazolyl, benzothiazolyl, oxazolyl, isoxazolyl, triazolyl, tetrazolyl, pyrazolyl, imidazolyl, thienyl, or any other radicals substituted, especially mono- or di-substituted, by e.g. alkyl, nitro or halogen. Pyridyl represents 2-, 3- or 4-pyridyl, advantageously 2- or 3-pyridyl. Thienyl represents 2- or 3-thienyl. Quinolinyl represents preferably 2-, 3- or 4-quinolinyl. Isoquinolinyl represents preferably 1-, 3- or 4-isoquinolinyl. Benzopyranyl, benzothiopyranyl represents preferably 3-benzopyranyl or 3-benzothiopyranyl, respectively. Thiazolyl represents preferably 2- or 4-thiazolyl, and most preferred 4-thiazolyl. Triazolyl is preferably 1-, 2- or 5-(1,2,4-triazolyl). Tetrazolyl is preferably 5-tetrazolyl.

Preferably, heteroaryl is pyridyl, indolyl, quinolinyl, pyrrolyl, thiazolyl, isoxazolyl, triazolyl, tetrazolyl, pyrazolyl, imidazolyl, thienyl, furanyl, benzothiazolyl, benzofuranyl, isoquinolinyl, benzothienyl, oxazolyl, indazolyl, or any of the radicals substituted, especially mono- or di-substituted.

The term “heteroalkyl” refers to an alkyl group having from 1 to 3 heteroatoms such as N, O and S. The heteroatoms can also be oxidized, such as, but not limited to, —S(O)— and —S(O)₂—. For example, heteroalkyl can include ethers, thioethers, alkyl-amines and alkyl-thiols.

The term “heteroalkylene” refers to a heteroalkyl group, as defined above, linking at least two other groups. The two moieties linked to the heteroalkylene can be linked to the same atom or different atoms of the heteroalkylene.

The term “heterocycloalkyl” refers to a ring system having from 3 ring members to about 20 ring members and from 1 to about 5 heteroatoms such as N, O and S. The heteroatoms can also be oxidized, such as, but not limited to, —S(O)— and —S(O)₂—. For example, heterocycle includes, but is not limited to, tetrahydrofuranyl, tetrahydrothiophenyl, morpholino, pyrrolidinyl, pyrrolinyl, imidazolidinyl, imidazolinyl, pyrazolidinyl, pyrazolinyl, piperazinyl, piperidinyl, indolinyl, quinuclidinyl and 1,4-dioxa-8-aza-spiro[4.5]dec-8-yl.

The term “heterocycloalkylene” refers to a heterocyclalkyl group, as defined above, linking at least two other groups. The two moieties linked to the heterocycloalkylene can be linked to the same atom or different atoms of the heterocycloalkylene.

The term “optionally substituted” is used herein to indicate a moiety that can be unsubstituted or substituted by one or more substituent. When a moiety term is used without specifically indicating as substituted, the moiety is unsubstituted.

In accordance with the disclosure, various ether and sulfonamide solvents may be used in electrolyte compositions.

Examples of ether solvents include, but are not limited to, cyclic ether compounds of Formula (1) or (2):

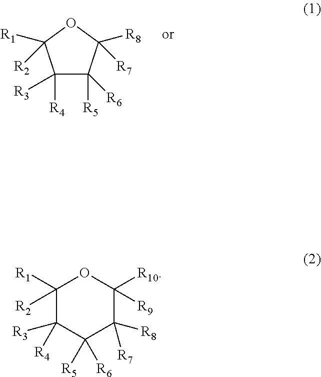

In some embodiments, R₁-R₁₀ may be the same or different and may be selected from H, F, CF₃, and/or C1-C10 alkyl, which may be optionally substituted. In other embodiments, R₁ is F; and R₂₋₁₀ may be H, F, CF₃, or C1-C10 alkyl, which may be optionally substituted. Exemplary ether solvents include tetrahydrofuran (THF), 2-fluoro-tetrahydrofuran (THF-1F), tetrahydropyran (THP) and 2-fluoro-tetrahydropyran (THP-1F), as shown below:

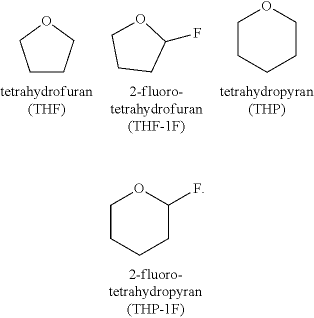

Linear ethers may also be used; examples of linear ether solvents include, but are not limited to, ether compounds of Formula (3) or (4):

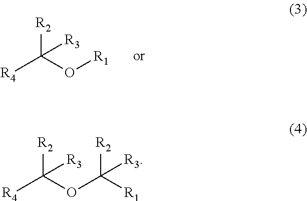

In some embodiments, R₁-R₄ may be the same or different and may be selected from H, F, CF₃, and/or C1-C10 alkyl, which may be optionally substituted. In further embodiments, R₄ may be linear or branched C1-C10 alkyl, which may be substituted with H, F, CF₃. In additional embodiments, R₄ may be linear or branched C1-C10 alkyl which is partially or completely fluorinated (H replaced with F), where all substituents are either H or F.

Exemplary linear ether compounds include, but are not limited to the following linear fluoroethers:

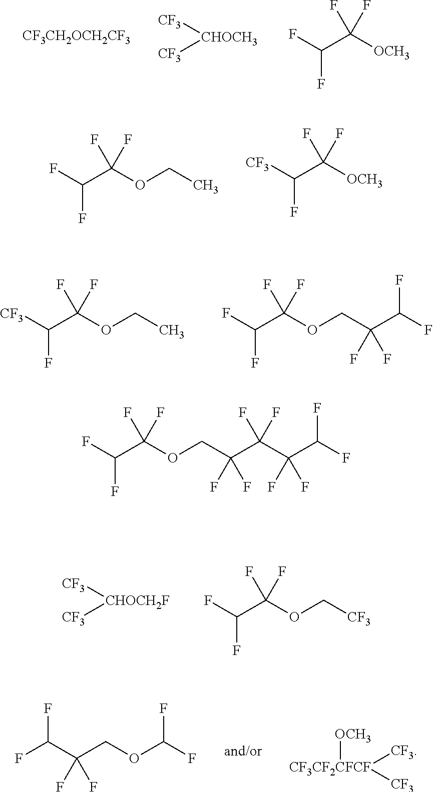

Certain linear ethers (glycol ethers; also known as glymes) may also be used; glyme compounds include, but are not limited to, the following Formulae (5), (6) and/or (7):

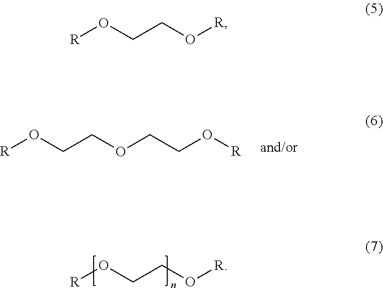

In Formula (7) each R may be the same or different and may be selected from CH₃, CH₂F, CHF₂, and/or CF₃; and n may be 1-20.

Examples of sulfonamide solvents include, but are not limited to, compounds of Formula (8) below:

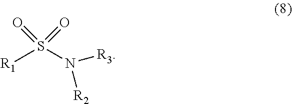

In Formula (8), R₁-R₃ may be the same or different and may be H, F, CF₃, and/or C1-C10 alkyl, which may be optionally substituted.

In some embodiments, one or more of the disclosed ether or sulfonamide solvent compounds may be combined with one or more lithium salts to create an electrolyte composition. These electrolyte compositions may be used in any electrochemical energy storage system, including (1) electrochemical energy storage system containing Silicon or SiOx as an electrode; (2) electrochemical energy storage systems containing lithium metal (or anodeless where the lithium comes from the cathode and is deposited on the bare anode current collector during the first charge) as anode, or (3) any Li-ion cell containing graphite as anode. In further embodiments, the active material in the electrode described above is at least 50% Si by weight (silicon dominant).

In some embodiments, there are two or more of the disclosed ether or sulfonamide solvent compounds in the electrolyte composition (co-solvents).

In certain embodiments, the salt used with the ether or sulfonamide solvent compounds is selected from the group consisting of lithium bis(fluorosulfonyl)imide (LiFSI), lithium hexafluorophosphate (LiPF₆), lithium tetrafluoroborate (LiBF₄), bis(trifluoromethanesulfonyl)imide (LiTFSI), lithium nitrate (LiNO₃), and lithium perchlorate (LiClO₄). The salt concentration can be 0.5M, 0.8M, 1 M, 1.2M, 1.5M, 2M, 3M or 4M or higher. In some embodiments, the concentration is from 0.5M-4M. In other embodiments, the concentration is less than 1 M, such as 0.1-0.7M. Lower concentration ranges are useful when two or more salts are used as one may be a major component and the other a minor component of the electrolyte composition.

The electrolyte composition may contain >20% of the disclosed ether or sulfonamide solvent compounds; in other embodiments, the electrolyte composition contains >50%, >80%, >90%, and around 100% of the disclosed ether or sulfonamide solvent compounds. Further, as set forth above, in some embodiments, a solvent of the electrolyte may be about 20 wt %, about 30 wt %, about 40 wt %, about 50 wt %, about 60 wt %, about 70 wt %, about 80 wt %, or about 90 wt % of the electrolyte composition. In some embodiments, a solvent may have a concentration from about 10 wt % to about 90 wt %, from about 10 wt % to about 80 wt %, from about 10 wt % to about 60 wt %, from about 20 wt % to about 60 wt %, from about 20 wt % to about 50 wt %, from about 30 wt % to about 60 wt %, from about 30 wt % to about 70 wt % or from about 30 wt % to about 50 wt %. Amounts may be measured as percent of total solvent.

In some embodiments, the electrolyte composition may have two or more components. In further embodiments, the electrolyte composition may have one solvent and one lithium salt; in another embodiment, the electrolyte composition may have two or more solvents and may also contain one or more lithium salts; in a further embodiment, the electrolyte composition may have three or more solvents and may also contain one or more lithium salts.

Specific examples of ether and sulfonamide solvents include, but are not limited to, the following:

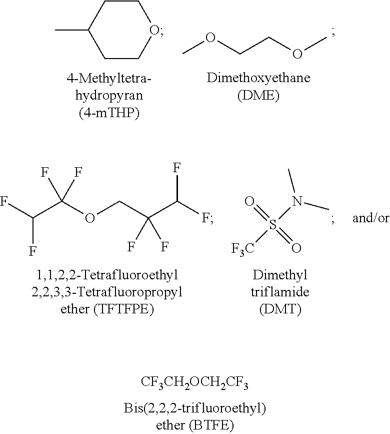

In some embodiments, a lithium ion battery comprising an electrolyte composition according to one or more embodiments described herein, and an anode having a composite electrode film according to one or more embodiments described herein, may demonstrate reduced gassing and/or swelling at about room temperature (e.g., about 20° C. to about 25° C.) or elevated temperatures (e.g., up to temperatures of about 85° C.), increased cycle life at about room temperature or elevated temperatures, and/or reduced cell growth/electrolyte consumption per cycle, for example compared to lithium ion batteries comprising conventionally available electrolyte compositions in combination with an anode having a composite electrode film according to one or more embodiments described herein. In some embodiments, a lithium ion battery comprising an electrolyte composition according to one or more embodiments described herein and an anode having a composite electrode film according to one or more embodiments described herein may demonstrate reduced gassing and/or swelling across various temperatures at which the battery may be subject to testing, such as temperatures between about −20° C. and about 130° C. (e.g., compared to lithium ion batteries comprising conventionally available electrolyte compositions in combination with an anode having a composite electrode film according to one or more embodiments described herein).

Gaseous byproducts may be undesirably generated during battery operation, for example, due to chemical reactions between the electrolyte and one or more other components of the lithium ion battery, such as one or more components of a battery electrode. Excessive gas generation during operation of the lithium ion battery may adversely affect battery performance and/or result in mechanical and/or electrical failure of the battery. For example, undesired chemical reactions between an electrolyte and one or more components of an anode may result in gas generation at levels which can mechanically (e.g., structural deformation) and/or electrochemically degrade the battery. The electrolyte compositions described herein may be advantageously utilized within an energy storage device. In some embodiments, energy storage devices may include batteries, capacitors, and battery-capacitor hybrids. In some embodiments, the energy storage device comprise lithium. In some embodiments, the energy storage device may comprise at least one electrode, such as an anode and/or cathode. In some embodiments, at least one electrode may be a Si-based electrode. In some embodiments, the Si-based electrode is a Si-dominant electrode, where silicon is the majority of the active material used in the electrode (e.g., greater than 50% silicon by weight). In some embodiments, the energy storage device comprises a separator. In some embodiments, the separator is between a first electrode and a second electrode.

In some embodiments, the second electrode is a Si-dominant electrode as described herein. In some embodiments, the second electrode comprises a self-supporting composite material film. In some embodiments, the composite material film comprises greater than 0% and less than about 95% by weight of silicon particles, and greater than 0% and less than about 90% by weight of one or more types of carbon phases, wherein at least one of the one or more types of carbon phases is a substantially continuous phase that holds the composite material film together such that the silicon particles are distributed throughout the composite material film.

In some embodiments, the battery may be capable of at least 200 cycles with more than 80% cycle retention when cycling with a C-rate of >2C cycling between an upper voltage of >4V and a lower cut-off voltage of <3.3V. In other embodiments, the battery may be capable of at least 200 cycles with more than 80% cycle retention when cycling with a C-rate of >2C cycling between an upper voltage of >4V and a lower cut-off voltage of <3.3V.

Electrolyte compositions are described herein that provide a lithium ion battery with improved performance. The electrolyte composition may vary in the solvents used (and the concentrations used when a multi-solvent system is utilized) and/or the salts used. As discussed above, a lithium ion battery comprising an electrolyte composition according to one or more embodiments described herein, and an anode and cathode according to one or more embodiments described herein, may demonstrate advantageous properties. Specifically, the electrolyte compositions disclosed herein provide one or more of the following benefits, especially when the cells are cycled and stored at high temperature with 100% State of Charge (SOC): 1) cycle life to 80% capacity; (2) better high temperature stability; (3) less gassing; (4) lower total cost; (5) improved total delivered energy to 80% capacity; and/or (6) improved safety (less flammable and less susceptible to thermal runaway).

The benefits may be attributed to superior chemical and electrochemical stability of the novel electrolyte chemistry, limiting extensive degradation of the electrode/electrolyte interface. Specifically considering the disclosed sulfonamide solvents, these provide one or more of the following benefits: (1) high chemical resistance; (2) stable interface with high-Ni cathode; (3) stable against singlet oxygen (suppressed gassing); (4) improved anode SEI properties (Li⁺ conductivity, formed without gassing, mainly inorganic nature); (5) improved safety (flame-retardant, etc.); and/or (6) high oxidative stability.

The lithium-ion batteries used in the experiments below may comprise Si-dominant anodes with a NCM811 cathode; and the electrolyte compositions described below. The cells may utilize a 5-layer pouch cell design (5 layers of double sided cathodes and 6 layers of double sided anodes).

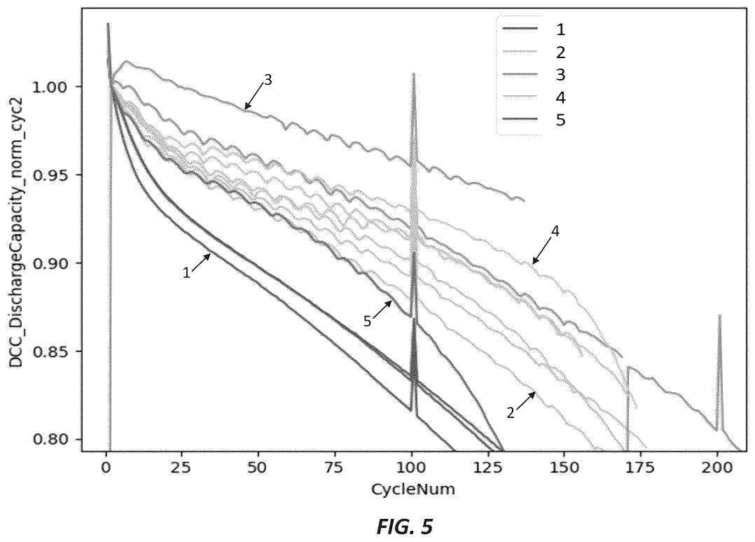

FIG. 5 shows the performance of different ether-based electrolytes (2-5) compared to a carbonate based electrolyte (1), where the electrolyte compositions are as follows in Table 1:

TABLE 1

| | | Solvent | vol. | Solvent | vol. |
|---|---|---|---|---|---|
| ID | Salt/Additive | 1 | % | 2 | % |
| 1 | 0.8M LiTFSI + 0.7M LiPF6 | FEC | 30 | EMC | 70 |
| | | | wt % | | wt % |
| 2 | 2M LiFSI + 0.2M LiNO3 | 4mTHP | 70 | DMT | 30 |
| 3 | 1.5M LiFSI + 0.5M LiPF6 | 4mTHP | 70 | TFTFPE | 30 |
| 4 | 1.5M LiFSI + 0.5M LiPF6 | 4mTHP | 70 | BTFE | 30 |
| 5 | 4M LiFSI + 0.2M LiNO3 | DME | 70 | DMT | 30 |

Greater than 1.4× improvement in cycle life may be achieved utilizing the above formulations as compared to the standard carbonate electrolyte (1).

According to Density Functional theory (DFT) calculations (B3LYP/6-31G**), fluorinating cyclic ethers especially in the 1-position leads to a significant deepening of the HOMO with minimal change in the LUMO energy (See Table 2 below). This indicates the possibility of a significant increase in their oxidation stability while still maintaining relatively high reduction stability.

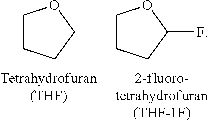

TABLE 2

| | HOMO (DFT) | LUMO (DFT) |
|---|---|---|
| THF | −6.7293 eV | −2.2712 eV |
| THF-1F | −7.5344 eV | −2.3691 eV |

Table 3 shows a 5-Layer Si/NCM811 pouch cell performance summary, measured at room temp. (25° C.) and high temperature (45° C.), comparing a Control electrolyte system vs. Sulfonamide vs. Sulfonamide+FEC electrolyte systems. Electrolyte compositions used in this experiment are shown in Table 4.

Greater than 1.6× improvement in cycle life may be achieved utilizing the below formulations as compared to the standard carbonate electrolyte (control).

TABLE 3

| | Room temperature cycling | | | High temperature cycling (45° C.) | | |
|---|---|---|---|---|---|---|
| | | | Sulfonamide + | | | Sulfonamide + |
| | Control | Sulfonamide | FEC | Control | Sulfonamide | FEC |
| Initial | 776 | 735 | 749 | 802 | 805 | 784 |
| capacity | | (−5.3%) | (−3.5%) | | (+0.4%) | (−2.1%) |
| (Cycle 2, | | | | | | |
| 4.1 V-2 V | | | | | | |
| @0.5 C, | | | | | | |
| mAh) | | | | | | |
| Cycles to | 76 | 125 | 128 | 78 | 103 | 143 |
| 80% | | (+64.4%) | (+68.4%) | | (+32.0%) | (+83.3%) |
| capacity | | | | | | |
| Total | 178 | 262 | 292 | 189 | 249 | 342 |
| delivered | | (+47.1%) | (+63.9%) | | (+31.3%) | (+80.7%) |
| energy | | | | | | |
| to 80% | | | | | | |
| capacity | | | | | | |
| (Wh) | | | | | | |

TABLE 4

| EL ID | Chemical composition |
|---|---|
| Control | 0.8M LiFSI + 0.7M LiPF6 in Fluoroethylene |
| | carbonate/Ethyl methyl carbonate/ |
| | Fluorobenzene (25/65/10 wt %) + |
| | 1 wt % phosphazene + 0.5 wt % LiDFOB |
| Sulfonamide | 0.8M LiFSI in N,N-dimethyl- |
| | trifluoromethanesulfonamide |
| Sulfonamide + FEC | 1M LiFSI in N,N-dimethyl- |
| | trifluoromethanesulfonamide/FEC |
| | (90/10 wt %) |

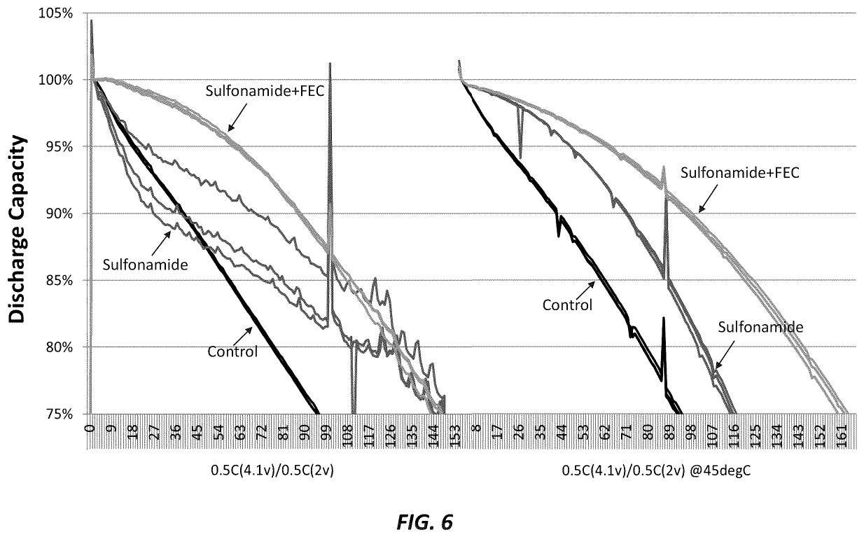

FIG. 6 shows normalized discharge capacity retention at room temperature and at high temperature cycling of 5-Layer pouch cells based on a Si anode, a NCM811 cathode, and a Control (black), Sulfonamide (red), and Sulfonamide+FEC (green) electrolyte. Compositions are listed in Table 4. Cycling protocol: 0.5C (4.1V) charge/0.5C (2.0V) discharge.

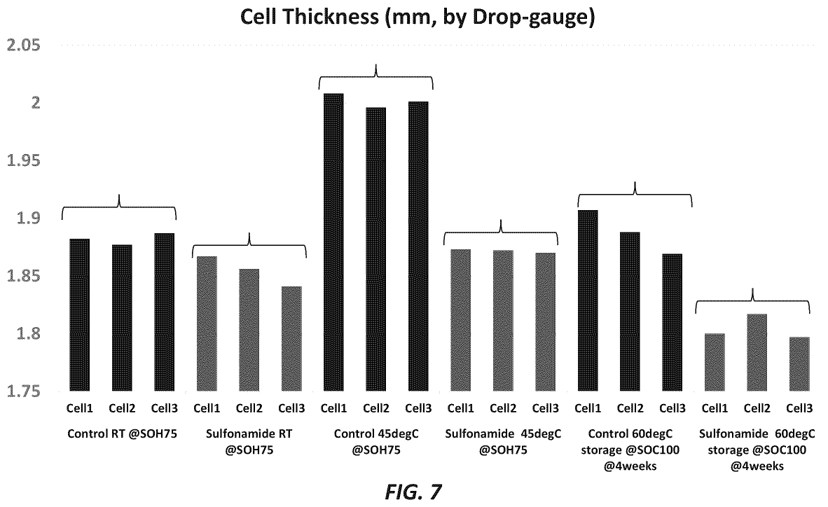

FIG. 7 shows gassing analysis of 5-Layer Si/NCM811 pouch cells comparing Control electrolyte (black) vs. Sulfonamide electrolyte (red). From left to right: at 75% State of Health (SOH) following room temperature cycling, at 75% SOH following 45° C. cycling, after 4 weeks of storage at 4.1 V at 60° C. Cells containing the electrolyte composition of the invention (sulfonamide) show less gassing as measured by cell thickness.

Table 5 shows the capacity recovery comparing a Control electrolyte (black) vs. Sulfonamide electrolyte (red) for a 5-Layer Si/NCM811 pouch cell capacity recovery during 60° C. storage at 100% SOC for 4 weeks.

TABLE 5

| Group | CellNum | Capacity Recovery |
|---|---|---|
| Control | 001 | 95.60% |
| | 002 | 96.91% |
| | 003 | 96.47% |
| Sulfonamide | 001 | 96.51% |
| | 002 | 97.23% |
| | 003 | 97.66% |

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, a battery, circuitry or a device is “operable” to perform a function whenever the battery, circuitry or device comprises the necessary hardware and code (if any is necessary) or other elements to perform the function, regardless of whether performance of the function is disabled or not enabled (e.g., by a user-configurable setting, factory trim, configuration, etc.).

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. An electrolyte composition for use in an energy storage device, wherein said electrolyte composition comprises one or more solvents and one or more lithium-containing salts;
wherein said one or more solvents is a cyclic ether of Formula (2): 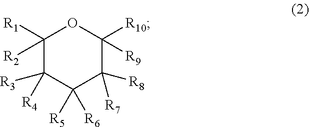
wherein R₁ is F; and R₂₋₁₀ is H, F, CF₃, or C1-C10 alkyl, which can be optionally substituted; and
wherein said electrolyte composition further contains one or more additives selected from the group consisting of FEC (Fluoroethylene carbonate), VC (vinylene carbonate), VEC (Vinyl ethylene carbonate), PS (1,3-propane sultone), PES (prop-1-ene-1,3-sultone), MMDS (methylene methanedisulfonate), TMSP (tris(trimethylsilyl) phosphite), TMS (trimethylene sulfate), TMSO (3-trimethylsilyl-2-oxazolidinone), 1,4-BS (1,4-butane sultone), PMS (propargyl methanesulfonate), BP (biphenyl), DTD (1,3,2-Dioxathiolane 2,2-dioxide), and TAP (Triallyl phosphate).

2. (canceled)

3. (canceled)

4. The electrolyte composition of claim 1, wherein the cyclic ether is 2-fluoro-tetrahydropyran (THP-1F).

5. The electrolyte composition of claim 1, wherein said one or more lithium-containing salts are selected from the group consisting of lithium bis(fluorosulfonyl)imide (LiFSI), lithium hexafluorophosphate (LiPF₆), lithium tetrafluoroborate (LiBF₄), bis(trifluoromethanesulfonyl)imide (LiTFSI), lithium nitrate (LiNO₃), lithium perchlorate (LiClO₄), Lithium difluoro(oxalato)borate (LiDFOB) and Lithium bis(oxalato)borate (LiBOB).

6. The electrolyte composition of claim 5, wherein said one or more lithium-containing salts are selected from the group consisting of lithium bis(fluorosulfonyl)imide (LiFSI), lithium hexafluorophosphate (LiPF₆), lithium nitrate (LiNO₃), Lithium difluoro(oxalato)borate (LiDFOB) and Lithium bis(oxalato)borate (LiBOB).

7. An electrolyte composition for use in an energy storage device, wherein said electrolyte composition comprises one or more solvents and one or more lithium-containing salts;
wherein said one or more solvents is a linear ether.

8. The electrolyte composition of claim 7, wherein said linear ether is of Formula (3) or (4): 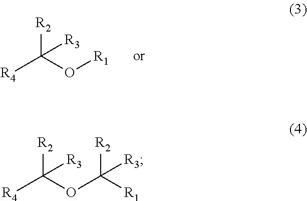
wherein R₁-R₄ is the same or different and is selected from the group consisting of H, F, CFs, and C1-C10 alkyl, which can be optionally substituted.

9. The electrolyte composition of claim 8, wherein R₄ is linear or branched C1-C10 alkyl, which is substituted with H, F, or CF₃.

10. The electrolyte composition of claim 7, wherein the linear ether is

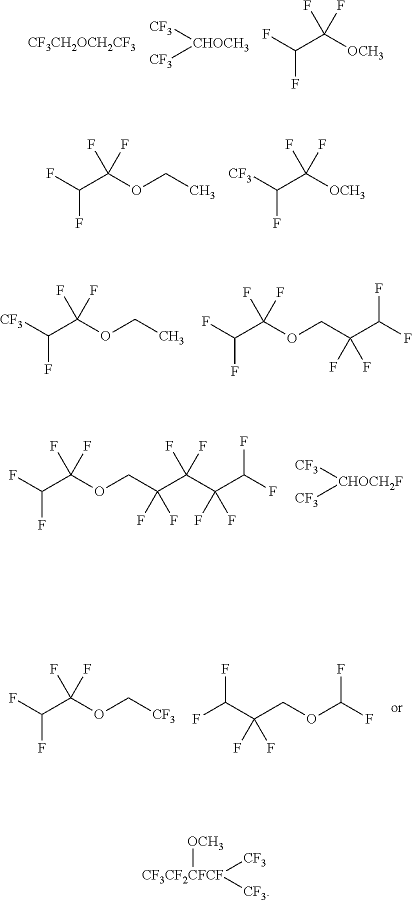

11. The electrolyte composition of claim 7, wherein said linear ether is of Formula (5), Formula (6) or Formula (7): 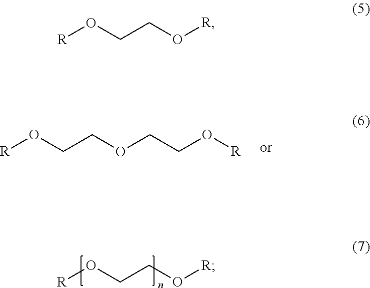
wherein each R is the same or different and is selected from the group consisting of CH₃, CH₂F, CHF₂, and CF₃; and n is 1-20.

12. The electrolyte composition of claim 7, wherein said one or more lithium-containing salts are selected from the group consisting of lithium bis(fluorosulfonyl)imide (LiFSI), lithium hexafluorophosphate (LiPF₆), lithium tetrafluoroborate (LiBF₄), bis(trifluoromethanesulfonyl)imide (LiTFSI), lithium nitrate (LiNO₃), lithium perchlorate (LiClO₄), Lithium difluoro(oxalato)borate (LiDFOB) and Lithium bis(oxalato)borate (LiBOB).

13. The electrolyte composition of claim 12, wherein said one or more lithium-containing salts are selected from the group consisting of lithium bis(fluorosulfonyl)imide (LiFSI), lithium hexafluorophosphate (LiPF₆), lithium nitrate (LiNO₃), Lithium difluoro(oxalato)borate (LiDFOB) and Lithium bis(oxalato)borate (LiBOB).

14. (canceled)

15. (canceled)

16. (canceled)

17. An electrolyte composition for use in an energy storage device, wherein said electrolyte composition comprises one or more solvents and one or more lithium-containing salts;
wherein said one or more solvents is a sulfonamide of Formula (8): 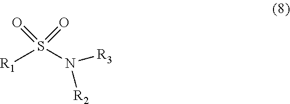
wherein each R₁-R₃ is the same or different and is selected from the group consisting of H, F, CFs, and C1-C10 alkyl, which can be optionally substituted.

18. The electrolyte composition of claim 17, wherein said one or more lithium-containing salts are selected from the group consisting of lithium bis(fluorosulfonyl)imide (LiFSI), lithium hexafluorophosphate (LiPF₆), lithium tetrafluoroborate (LiBF₄), bis(trifluoromethanesulfonyl)imide (LiTFSI), lithium nitrate (LiNO₃), lithium perchlorate (LiClO₄), Lithium difluoro(oxalato)borate (LiDFOB) and Lithium bis(oxalato)borate (LiBOB).

19. The electrolyte composition of claim 18, wherein said one or more lithium-containing salts are selected from the group consisting of lithium bis(fluorosulfonyl)imide (LiFSI), lithium hexafluorophosphate (LiPF₆), lithium nitrate (LiNO₃), Lithium difluoro(oxalato)borate (LiDFOB) and Lithium bis(oxalato)borate (LiBOB).

20. (canceled)

21. The electrolyte composition of claim 1, wherein said additive is present in an amount of about 0.1%-30% by weight.

22. The electrolyte composition of claim 1, wherein said electrolyte composition further contains one or more additional components selected from the group consisting of the following solvents EC (ethylene carbonate), FEC (Fluoroethylene carbonate), PC (propylene carbonate), EMC (ethyl methyl carbonate), DMC (dimethyl carbonate), DEC (diethyl carbonate), GBL (gamma butyrolactone), MA (methyl acetate), EA (ethyl acetate), t-BC (trans-butylene carbonate), and PMC (propyl methyl carbonate).

23. The electrolyte composition of claim 22, wherein said additional component is present in an amount of about 0.1%-80% by weight.
